(19) United States
(12) Patent Application Publication
(10) Pub. No.: US 2026/0162652 A1
(43) Pub. Date: Jun. 11, 2026

(54) EMOTION CLASSIFICATION METHOD AND APPARATUS

(71) Applicant: MASHANG CONSUMER FINANCE CO., LTD., Chongqing (CN)

(72) Inventors: Zengping CHEN, Chongqing (CN); Wanjie TAO, Chongqing (CN)

(21) Appl. No.: 19/093,146

(22) Filed: Mar. 27, 2025

(30) Foreign Application Priority Data
Dec. 6, 2024 (CN) 202411793531.0

(51) Int. Cl. G10L 15/08; G10L 15/06; G10L 15/26; G10L 25/63

(52) U.S. Cl. CPC G10L 15/083; G10L 15/063; G10L 15/26; G10L 25/63

(57) ABSTRACT

In an emotion classification model training method, a training object and an emotion classification model are obtained. An audio vector of the training object and a text vector of the training object are added to a transformation layer of the emotion classification model. A transformed audio feature vector of a sample of the training object is obtained based on the transformation layer. A transformed text feature vector of the sample of the training object is obtained based on the transformation layer. Classification is performed based on the transformed audio feature vector, the transformed text feature vector, and a linear layer of the emotion classification model. An adjustment is obtained based on an emotion classification result of the sample of the training object. The audio vector, the text vector, and the linear layer of the emotion classification result are updated based on the adjustment.

### RELATED APPLICATION

The present application claims priority to Chinese Patent Application No. 202411793531.0, filed on Dec. 6, 2024, which is hereby incorporated by reference in its entirety.

### FIELD OF THE TECHNOLOGY

This disclosure relates to the field of information processing, including to an emotion classification model training method and apparatus, an emotion classification method and apparatus, an electronic device, a computer-readable storage medium, and a computer program product.

### BACKGROUND OF THE DISCLOSURE

Emotion recognition is widely applied to intelligent telemarketing and customer service scenarios. Some emotion classification models perform classification based on text content, but accuracy of these models is low due to a lack of voice information. Some emotion classification models are trained using a fine-tuning method and perform emotion recognition based on both text and voice information. However, such a model training method requires a large amount of data and is costly.

### SUMMARY

Aspects of this disclosure provide an emotion classification model training method and apparatus, an electronic device, a computer-readable storage medium, and a computer program product, to reduce model training costs and improve accuracy of a trained emotion classification model.

In an aspect of this disclosure, an emotion classification model training method is provided. In the method, a training object and an emotion classification model are obtained. An audio vector of the training object and a text vector of the training object are added to a transformation layer of the emotion classification model. A transformed audio feature vector of a sample of the training object is obtained based on the transformation layer. A transformed text feature vector of the sample of the training object is obtained based on the transformation layer. Classification is performed based on the transformed audio feature vector, the transformed text feature vector, and a linear layer of the emotion classification model. An adjustment is obtained based on an emotion classification result of the sample of the training object. The audio vector, the text vector, and the linear layer of the emotion classification result are updated based on the adjustment.

An aspect of this disclosure further provides an emotion classification method. In the method, for an object whose emotion is to be classified, an emotion classification model is invoked to perform classification based on a text feature vector and an audio feature vector of the object.

An aspect of this disclosure provides an emotion classification model training apparatus, including processing circuitry.
an addition module, configured to add an audio prompt vector and a text prompt vector to a transformation layer of an emotion classification model;
a transformation module, configured to transform an audio feature vector of a sample object by using the transformation layer, to obtain a transformed audio feature vector, and transform a text feature vector of the sample object by using the transformation layer, to obtain a transformed text feature vector;
a prediction module, configured to perform classification based on the transformed audio feature vector and the transformed text feature vector by using a linear layer included in the emotion classification model, to obtain an emotion classification result of the sample object; and
an update module, configured to update the audio prompt vector, the text prompt vector, and the linear layer based on difference between the emotion classification result and a pre-added label.

In an aspect of this disclosure, an emotion classification apparatus including processing circuitry is provided. The processing circuitry is configured to obtain a training object and an emotion classification model. The processing circuitry is configured to add an audio vector of the training object and a text vector of the training object to a transformation layer of the emotion classification model. The processing circuitry is configured to obtain a transformed audio feature vector of a sample of the training object based on the transformation layer, and obtain a transformed text feature vector of the sample of the training object based on the transformation layer. The processing circuitry is configured to perform classification based on the transformed audio feature vector, the transformed text feature vector, and a linear layer of the emotion classification model. The processing circuitry is configured to obtain an adjustment based on an emotion classification result of the sample of the training object. The processing circuitry is configured to update the audio vector, the text vector, and the linear layer of the emotion classification result based on the adjustment.

An aspect of this disclosure provides an electronic device, including a memory and a processor. The memory is configured to store computer-executable instructions or a computer program. The processor is configured to execute the computer-executable instructions or the computer program stored in the memory, to implement the emotion classification model training method or the emotion classification method according to this disclosure.

An aspect of this disclosure provides a non-transitory computer-readable storage medium, having a computer program or computer-executable instructions stored thereon, when the computer program or the computer-executable instructions being executed by a processor to perform the emotion classification model training method or the emotion classification method according to this disclosure.

An aspect of this disclosure provides a computer program product, including a computer program or computer-executable instructions, the computer program or the computer-executable instructions implementing, when executed by a processor, the emotion classification model training method or the emotion classification method according to aspects of this disclosure.

Aspects of this disclosure have the following beneficial effects:

Parameters of a pre-trained transformer model included in an emotion classification model are kept unchanged, and a linear layer included in the emotion classification model, an audio prompt vector, and a text prompt vector are updated based on difference between a predicted emotion classification result and a pre-added label, so that parameters needing to be adjusted for model training are reduced. In this way, an amount of data required for model training can be effectively reduced, thereby reducing model training costs. In addition, because information of two dimensions (e.g., audio and text) is involved in a model training process, classification by combining the information of the two dimensions can improve accuracy of a trained emotion classification model.

### BRIEF DESCRIPTION OF THE DRAWINGS

FIG. 1 is a schematic diagram of an architecture of an emotion classification model training system 100 according to an aspect of this disclosure.

FIG. 2A is a schematic diagram of a structure of an electronic device 500 according to an aspect of this disclosure.

FIG. 2B is a schematic diagram of a structure of an electronic device 600 according to an aspect of this disclosure.

FIG. 3 is a schematic flowchart of an emotion classification model training method according to an aspect of this disclosure.

FIG. 4 is a schematic flowchart of an emotion classification model training method according to an aspect of this disclosure.

FIG. 5 is a schematic flowchart of an emotion classification model training method according to an aspect of this disclosure.

FIG. 6 is a schematic diagram of an emotion classification model training method according to an aspect of this disclosure.

### DETAILED DESCRIPTION

The following describes the disclosure in further detail with reference to the accompanying drawings. The described aspects are not to be considered as a limitation to this disclosure. Other aspects are within the scope of this disclosure.

Descriptions of terms in this disclosure are provided as examples only and are not intended to limit the scope of the disclosure.

In the following description, the term “some aspects” describes subsets of possible aspects, but “some aspects” may be the same subset or different subsets of the possible aspects, and can be combined with each other without conflict.

The term “layer” or “unit” refers to a computer program having a predetermined function or a part of a computer program, and works together with other related parts to achieve a predetermined objective, and may be implemented by using software, hardware (such as a processing circuit and/or a memory), or a combination thereof. Similarly, one processor (or a plurality of processors or memories) may be used to implement one or more layers or units. In addition, each layer or unit may be a part of an entire layer or unit including a function of the layer or unit.

In the following descriptions, the terms “first”, “second”, and the like involved are merely intended to distinguish between objects rather than describe specific orders. The terms “first”, “second”, and the like is interchangeable in a particular order or sequence if permitted, so that examples described herein may be performed in an order other than that illustrated or described herein. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Meanings of technical and scientific terms used in this specification are the same as those understood by a person skilled in the art. Terms used in the specification are merely intended to describe objectives of examples of this disclosure, but are not intended to limit this disclosure.

Before aspects of this disclosure are further described in detail, example descriptions are made on terms in aspects of this disclosure, and the terms in aspects of this disclosure are applicable to the following explanations.

(1) Prompt tuning: The prompt tuning is to guide, by using trainable prompt information, a model to output a result required by a task. The prompt information may be text, audio, or vector information, and is configured for helping the model understand a specific task or requirement.

(2) Fine-tuning: The fine-tuning is mainly for performing fine tuning of a specific task based on a pre-trained model, and needs to train all parameters of the model. When dealing with a particular downstream task (for example, emotion analysis or text classification), the pre-trained model does not need to be trained from scratch due to its generalization capability.

(3) Transformer model: The transformer model is a self-attention mechanism-based deep learning model, which captures a long-distance dependency relationship in sequence data by using the self-attention mechanism, and handles sequence-to-sequence transformation by using a coder-decoder structure.

(4) Self-attention mechanism: The self-attention mechanism is a mechanism widely used in sequence task processing, especially in the field of natural language processing (NLP). The self-attention mechanism means that given a sequence (for example, a word sequence in a sentence), each element (for example, a word) references all other elements in the sequence. A core of the self-attention mechanism is to calculate a weight matrix. The matrix represents the “attention” each element in the sequence pays to other elements. The weight matrix is calculated by using a dot product of three vectors: query, key, and value. The self-attention mechanism can capture a long-distance dependency relationship in a sequence, and can establish an association between different locations.

Emotion classification is widely applied to intelligent telemarketing and customer service scenarios. Emotions of customers may be classified according to text and voice information in conversations with the customers, to learn whether the customers currently have negative emotions and need appeasing or the like.

In the related art, an emotion classification model mainly performs classification based on text content. According to such a method, accuracy of emotion classification is low due to a lack of voice information. For example, in some cases, a customer's emotion is “very angry”, but this cannot be well reflected in text information alone. For example, the same text content “no need” can convey completely different emotions depending on how the customer expresses, for example, expresses loudly and angrily or softly and kindly. Therefore, introduction of voice information to the emotion classification model is of great importance to the accuracy of emotion classification.

In addition, in an emotion classification model provided in the related art, both text information and voice information are used, and pre-training text and voice are fitted through fine-tuning for an emotion classification task. However, this training method requires a large amount of training data, and training levels between modalities are inconsistent.

On this basis, aspects of this disclosure provide an emotion classification model training method and apparatus, an electronic device, a computer-readable storage medium, and a computer program product, to reduce model training costs and improve accuracy of a trained emotion classification model. The electronic device provided in this aspect of this disclosure may be implemented as a server, or may be jointly implemented by a server and a terminal. A description is provided below by using an example in which a server and a terminal jointly implement the emotion classification model training method according to aspects of this disclosure.

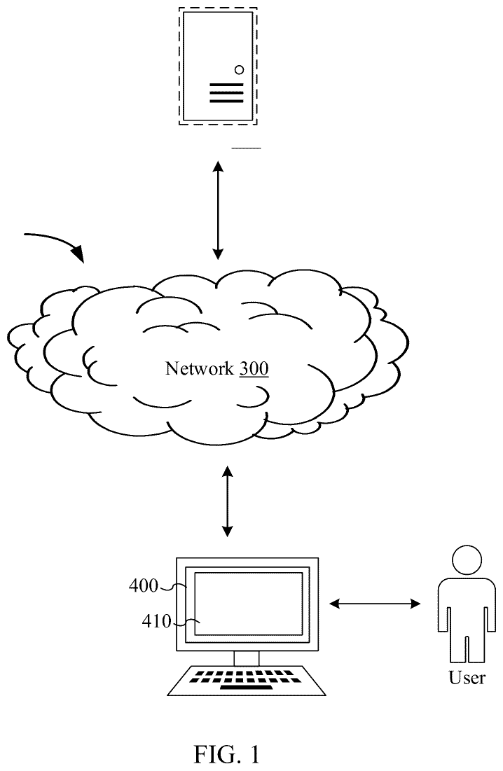

For example, FIG. 1 is a schematic diagram of an architecture of an emotion classification model training system 100 according to an aspect of this disclosure. In an example of training of an emotion classification model, as shown in FIG. 1, the emotion classification model training system 100 includes: a server 200, a network 300, and a terminal 400. The terminal 400 is connected to the server 200 through the network 300. The network 300 may be a local area network or a wide area network, or a combination thereof. The terminal 400 is a terminal associated with a user, a client 410 runs on the terminal 400, and the client 410 may be any of clients of various types, for example, including a dedicated model training client, a client or a browser related to intelligent telemarketing and customer services.

In some aspects, the server 200 may extract features of a sample object, to obtain an audio feature and a text feature of the sample object. Next, the server 200 performs embedding processing on the audio feature and the text feature of the sample object, to obtain an audio feature vector and a text feature vector. Next, the server 200 adds an audio prompt vector and a text prompt vector to a transformation layer of the emotion classification model, transforms the audio feature vector of the sample object by using the transformation layer, to obtain a transformed audio feature vector, and transforms the text feature vector of the sample object by using the transformation layer, to obtain a transformed text feature vector. Subsequently, the server 200 performs classification based on the transformed audio feature vector and the transformed text feature vector by using a linear layer of the emotion classification model, to obtain an emotion classification result of the sample object. Then, the server 200 updates the audio prompt vector, the text prompt vector, and the linear layer based on difference between the emotion classification result and a pre-added label, to obtain a trained emotion classification model. Finally, the server 200 may send the trained emotion classification model to the terminal 400 through the network 300, that is, may deploy the trained emotion classification model in the client 410 on the terminal 400.

The technical solutions provided in aspects of this disclosure may be applied to various application scenarios, including, for example, a plurality of scenarios such as intelligent telemarketing, intelligent customer service, social media monitoring, public opinion analysis, and smart home systems. For example, the trained emotion classification model may be deployed in an intelligent customer service client, to perform emotion classification based on audio and text features of a customer, to accurately determine a current emotion of the customer and provide a corresponding intelligent service. For example, the trained emotion classification model may be applied to a social media monitoring scenario. Brand and market analysts detect public sentiments on social media by using the emotion classification model, to learn how the public perceives their products or services, so as to help companies identify potential issues in a timely manner and take necessary measures.

Some aspects of this disclosure may be implemented by using a cloud technology. The cloud technology is a hosting technology that unifies a series of resources such as hardware, software, and networks in a wide area network or a local area network to implement computing, storage, processing, and sharing of data.

The cloud technology is a general term of network technologies, information technologies, integration technologies, management platform technologies, application technologies, and the like, applied to a cloud computing business model, and may form a resource pool to satisfy what is needed in a flexible and convenient manner. A cloud computing technology is to become an important support. A background service of a technical network system requires a large amount of computing and storage resources.

For example, the server 200 in FIG. 1 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal 400 may be a smartphone, a tablet computer, a notebook computer, a desktop computer, a smart speaker, a smartwatch, a vehicle-mounted terminal, or the like, but is not limited thereto. The terminal 400 and the server 200 may be connected directly or indirectly in a wired or wireless communication manner. This is not limited in aspects of this disclosure.

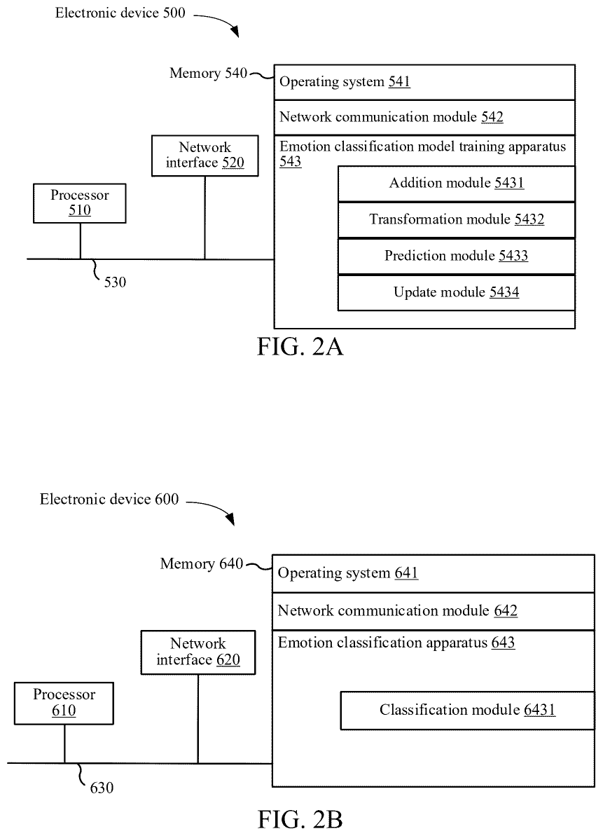

A structure of the electronic device provided in this aspect of this disclosure to implement the emotion classification model training method is described below. An example in which an electronic device 500 is a server is used. FIG. 2A is a schematic diagram of a structure of the electronic device 500 according to an aspect of this disclosure. The electronic device 500 shown in FIG. 2A includes: at least one processor 510, a memory 540, and at least one network interface 520. All components in the electronic device 500 are coupled together by using a bus system 530. The bus system 530 is configured to implement connection and communication between the components. In addition to a data bus, the bus system 530 further includes a power bus, a control bus, and a state signal bus. However, for clear description, various types of buses in FIG. 2A are marked as the bus system 530.

Processing circuitry, such as the processor 510 may be an integrated circuit chip with a signal processing capability, such as a general-purpose processor, a digital signal processor (DSP), or another programmable logic device, discrete gate or transistor logic device, or discrete hardware component. The general-purpose processor may be a microprocessor, any conventional processor, or the like.

The memory 540, such as a non-transitory computer-readable storage medium, may be removable, non-removable, or a combination thereof. For example, a hardware device includes a solid-state memory, a hard disk drive, an optical drive, and the like. In an aspect, the memory 540 includes one or more storage devices physically located away from the processor 510.

The memory 540 may include a volatile memory or a non-volatile memory, or may include both a volatile memory and a non-volatile memory. The non-volatile memory may be a read-only memory (ROM), and the volatile memory may be a random access memory (RAM). The memory 540 described in this aspect of this disclosure is intended to include any suitable type of memory.

In an example, the memory 540 can store data to support various operations, and examples of the data include a program, a module, and a data structure, or a subset or a superset thereof, which are exemplarily described below.

An operating system 541 includes system programs for processing various basic system services and performing hardware-related tasks, for example, a frame layer, a core library layer, and a drive layer, and is configured to implement various basic services and processing hardware-based tasks.

A network communication module 542 is configured to reach another computing device through one or more (wired or wireless) network interfaces 520. Exemplarily, the network interface 520 includes: Bluetooth, wireless fidelity (Wi-Fi), or a universal serial bus (USB).

In an example, the apparatus may be implemented in the form of software. FIG. 2A shows an emotion classification model training apparatus 543 stored in the memory 540. The apparatus 543 may be software in the form of a program, a plug-in, or the like, and includes the following software modules: an addition module 5431, a transformation module 5432, and a prediction module 5433, and an update module 5434. These modules are logical, so that the modules can be arbitrarily combined or split based on functions to be implemented.

The following continues to describe a structure of an electronic device for implementing an emotion classification method according to an example of this disclosure. An example in which an electronic device 600 is a server is used. FIG. 2B is a schematic diagram of a structure of the electronic device 600 according to an aspect of this disclosure. The electronic device 600 shown in FIG. 2B includes an emotion classification apparatus 643, which may be software in the form of a program, a plug-in, or the like, and includes the following software module: a classification module 6431. Functions of the modules are described below.

A processor 610, a network interface 620, a bus system 630, a memory 640, an operating system 641, and a network communications module 642 included in the electronic device 600 shown in FIG. 2B have identical structures and identical functions as corresponding modules included in FIG. 2A. Details are not described herein again in this aspect of this disclosure.

The following describes the emotion classification model training method according to aspects of this disclosure in further detail.

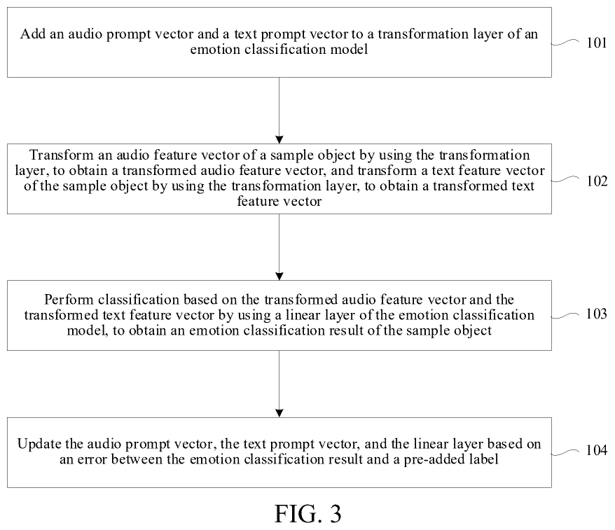

FIG. 3 is a schematic flowchart of an emotion classification model training method according to an aspect of this disclosure, which is described with reference to operations shown in FIG. 3.

Operation 101: Add an audio prompt vector and a text prompt vector to a transformation layer of an emotion classification model.

Herein, a to-be-trained audio prompt vector and text prompt vector may be added to the transformation layer of the emotion classification model. The emotion classification model is trained through prompt tuning. Output of the model is guided by updating the audio prompt vector and the text prompt vector, without needing to update a large quantity of parameters of the model, so that training costs of the model are effectively reduced.

Operation 102: Transform an audio feature vector of a sample object by using the transformation layer, to obtain a transformed audio feature vector, and transform a text feature vector of the sample object by using the transformation layer, to obtain a transformed text feature vector.

The series of transformation operations performed in the transformation layer may be a linear transformation, or may be a nonlinear transformation (for example, a convolutional layer, a recurrent layer, or an attention mechanism layer). This is not specifically limited herein.

For example, assuming that the convolutional layer is used, during processing of the audio feature vector, the convolutional layer may be used to extract a time-frequency feature, and during processing of the text feature vector, the convolutional layer may be used to extract a relationship between words. Assuming that a self-attention mechanism layer is used, different parts of a sequence may be simultaneously followed by using a multi-head attention layer in a transformer, to extract a dependency relationship between features. Assuming that a fully-connected layer is used, an input feature may be transformed into an output feature in any dimension. In this way, through the foregoing transformation process, the original audio and text feature vectors are transformed into forms more suitable for a machine learning model to process, so that performance and a generalization capability of the model are effectively improved.

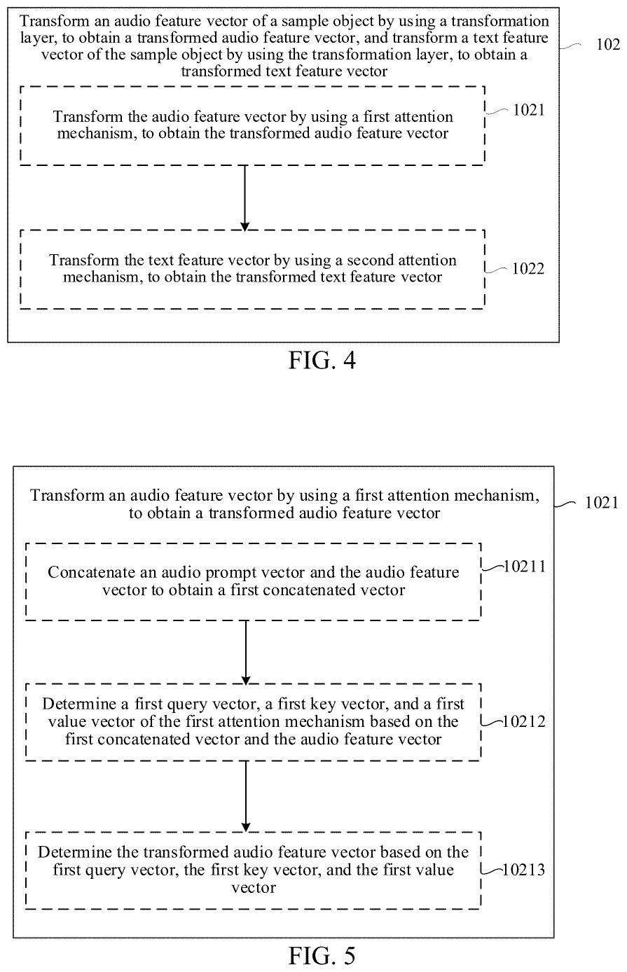

In an aspect, the transformation layer may include a first attention mechanism and a second attention mechanism. FIG. 4 is a schematic flowchart of an emotion classification model training method according to an aspect of this disclosure. As shown in FIG. 4, operation 102 shown in FIG. 3 may be implemented by operation 1021 and operation 1022 shown in FIG. 4. A description is to be provided with reference to operations shown in FIG. 4.

Operation 1021: Transform the audio feature vector by using the first attention mechanism, to obtain the transformed audio feature vector.

The attention mechanism here is a mechanism that allows the model to dynamically allocate attention according to importance of different parts of data during processing of input data. The first attention mechanism may have a plurality of forms, such as multi-head self-attention or sequence-to-sequence attention. In an example, the multi-head self-attention is a key part of the transformer model, divides an input sequence into a plurality of parts, separately calculates attention for each part, and then combines attention outputs to obtain a final sequence representation. The sequence-to-sequence attention can be used in an encoder-decoder architecture, and enables an encoder to pay attention to a sequence generated by a decoder, to generate a target sequence more accurately.

FIG. 5 is a schematic flowchart of an emotion classification model training method according to an aspect of this disclosure. As shown in FIG. 5, operation 1021 shown in FIG. 4 may be implemented by operation 10211 to operation 10213 shown in FIG. 5. A description is to be provided with reference to operations shown in FIG. 5.

Operation 10211: Concatenate the audio prompt vector and the audio feature vector to obtain a first concatenated vector.

For example, it is assumed that the audio prompt vector may include information such as a style (a character string, such as “melodious” or “noisy”), an emotion (a word describing an emotion, such as “happy” or “sad”), and a timbre (a word indicating a sound of a specific type, such as “piano” or “noise”). The audio prompt vector here may be a discrete label or a continuous value, and is not specifically limited herein. It is assumed that the audio feature vector may include information such as a pitch (that is, a volume of an audio) and a speed (that is, a playback speed of a sound or a rate of speaking in the audio). Next, the audio prompt vector is concatenated with the audio feature vector. A specific concatenation scheme may be: adjusting a dimension of the audio prompt vector to match a dimension of the audio feature vector, and then sequentially concatenating the audio prompt vector and the audio feature vector. Alternatively, a certain form of transformation may be performed on the audio prompt vector before concatenation, to better integrate with the audio feature vector. A specific concatenation method may be specifically determined according to a requirement of the model, and is not specifically limited herein. Finally, a first concatenated vector is obtained. The first concatenated vector includes a composite vector of audio prompt vector information and audio feature vector information.

Operation 10212: Determine a first query vector, a first key vector, and a first value vector of the first attention mechanism based on the first concatenated vector and the audio feature vector.

In the first attention mechanism, the first query vector describes information that the model wants to understand, or a part that the model wants to pay attention to and search for when exploring the input data. The first key vector includes information known by the model, or is a part used by the model to index information in the input data. The first value vector represents information associated with a key vector, or a “value” to which the first key vector points. To be specific, the first value vector includes actual information that the model needs to use, such as words in text and frequencies in audio.

In an example, operation 10212 may be implemented in the following manner: multiplying the audio feature vector by a first weight matrix, and using an obtained first multiplication result as the first query vector; multiplying the first concatenated vector by a second weight matrix, and using an obtained second multiplication result as the first key vector; and multiplying the first concatenated vector by a third weight matrix, and using an obtained third multiplication result as the first value vector.

The audio prompt vector and a pre-trained transformer model form an audio transformation layer; the first weight matrix, the second weight matrix, and the third weight matrix are determined by the pre-trained transformer model in a pre-training process; the first weight matrix is a corresponding weight matrix in the first query vector; the second weight matrix is a corresponding weight matrix in the corresponding first key vector; and the third weight matrix is a corresponding weight matrix in the first value vector.

For example, it is assumed that the audio prompt vector is Pᵥ, the audio feature vector is Xᵥ, the first weight matrix obtained from the pre-trained transformer model is W_{Qv}, the second weight matrix is W_{Kv}, and the third weight matrix is W_{Vv}. First, the audio prompt vector Pᵥ and the audio feature vector Xᵥ are concatenated. Assuming that an obtained first concatenated vector is P_Xᵥ, the audio feature vector Xᵥ is multiplied by the first weight matrix W_{Qv} to obtain a first multiplication result Xᵥ·W_{Qv}. In other words, the first query vector Qᵥ is Xᵥ·W_{Qv}. The first concatenated vector P_Xᵥ is multiplied by the second weight matrix W_{Kv} to obtain a second multiplication result P_Xᵥ·W_{Kv}. In other words, the first key vector Kᵥ is P_Xᵥ·W_{Kv}. The first concatenated vector P_Xᵥ is multiplied by the third weight matrix W_{Vv} to obtain a third multiplication result P_Xᵥ W_{Vv}. In other words, the first value vector Vᵥ is P_Xᵥ·W_{Vv}.

Operation 10213: Determine the transformed audio feature vector based on the first query vector, the first key vector, and the first value vector.

In an example, operation 10213 may be implemented in the following manner: transposing the first key vector to obtain a transposed first key vector; multiplying the transposed first key vector by the first query vector to obtain a fourth multiplication result; dividing the fourth multiplication result by a square root of a dimension of the first key vector to obtain a first division result; normalizing the first division result to obtain a normalized first division result; and multiplying the normalized first division result by the first value vector, and using an obtained fifth multiplication result as the transformed audio feature vector.

For example, it is assumed that the first query vector is Qᵥ, the first key vector is Kᵥ, the first value vector is Vᵥ, the dimension of the first key vector is dkᵥ. The first key vector Kᵥ is transposed to obtain a transposed first key vector Kᵥ^{T}. The transposed first key vector Kᵥ^{T} is multiplied by the first query vector Qᵥ to obtain a fourth multiplication result QᵥKᵥ^{T}. The fourth multiplication result QᵥKᵥ^{T} is divided by a square root \sqrt{dkᵥ} of the dimension of the first key vector to obtain a first division result

$$\frac{{Q}_{v} {K}_{v}^{T}}{\sqrt{{dk}_{v}}} .$$

The first division result

$$\frac{{Q}_{v} {K}_{v}^{T}}{\sqrt{{dk}_{v}}}$$

is normalized by using a softmax function to obtain a normalized first division result

$$softmax ( \frac{{Q}_{V} {K}_{v}^{T}}{\sqrt{d {k}_{v}}} ) .$$

Finally, the normalized first division result

$$softmax ( \frac{{Q}_{v} {K}_{v}^{T}}{\sqrt{d {k}_{v}}} )$$

multiplied by the first value vector Vᵥ to obtain a fifth multiplication result softmax( )Vᵥ. In other words, the transformed audio feature vector is

$$softmax ( \frac{{Q}_{v} {K}_{v}^{T}}{\sqrt{d {k}_{v}}} ) {V}_{v} .$$

Operation 1022: Transform the text feature vector by using the second attention mechanism, to obtain the transformed text feature vector.

Herein, the first attention mechanism and the second attention mechanism may be the same, or may be different. This is not specifically limited herein.

The implementation of operation 1022 in this aspect of this disclosure can be similar to the implementation of operation 1021. Reference may be made to the implementation of operation 1021. Details are not described here.

In an example, operation 1022 may be implemented in the following manner: concatenating the text prompt vector and the text feature vector to obtain a second concatenated vector; determining a second query vector, a second key vector, and a second value vector of the second attention mechanism based on the second concatenated vector and the text feature vector; and determining the transformed text feature vector based on the second query vector, the second key vector, and the second value vector.

In an example, the determining a second query vector, a second key vector, and a second value vector of the second attention mechanism based on the second concatenated vector and the text feature vector may be implemented in the following manner: multiplying the text feature vector by a fourth weight matrix, and using an obtained sixth multiplication result as the second query vector; multiplying the second concatenated vector by a fifth weight matrix, and using an obtained seventh multiplication result as the second key vector; and multiplying the second concatenated vector by a sixth weight matrix, and using an obtained eighth multiplication result as the second value vector.

The fourth weight matrix is a corresponding weight matrix in the second query vector, the fifth weight matrix is a corresponding weight matrix in the corresponding second key vector, and the sixth weight matrix is a corresponding weight matrix in the second value vector.

For example, it is assumed that the text prompt vector is Pₜ, the text feature vector is Xₜ, the fourth weight matrix obtained from the pre-trained transformer model is W_{Qt}, the fifth weight matrix is W_{Kt}, and the sixth weight matrix is W_{Vt}. First, the text prompt vector Pₜ and the text feature vector Xₜ are concatenated. Assuming that an obtained second concatenated vector is P_Xₜ, the text feature vector Xₜ is multiplied by the fourth weight matrix W_{Qt} to obtain a sixth multiplication result Xᵥ·W_{Qt}. In other words, the second query vector Qt is Xₜ·W_{Qt}. The second concatenated vector P_Xₜ is multiplied by the fifth weight matrix W_{Kt} to obtain a seventh multiplication result P_Xₜ·W_{Kt}. In other words, the second key vector Kₜ is P_Xᵥ·W_{Kt}. The second concatenated vector P_Xₜ is multiplied by the sixth weight matrix W_{Vt} to obtain an eighth multiplication result P_Xₜ·W_{Vt}. In other words, the second value vector Vₜ is P_Xₜ·W_{Vt}.

In an example, the determining the transformed text feature vector based on the second query vector, the second key vector, and the second value vector may be implemented in the following manner: transposing the second key vector to obtain a transposed second key vector; multiplying the transposed second key vector by the second query vector to obtain a ninth multiplication result; dividing the ninth multiplication result by a square root of a dimension of the second key vector to obtain a second division result; normalizing the second division result to obtain a normalized second division result; and multiplying the normalized second division result by the second value vector, and using an obtained tenth multiplication result as the transformed text feature vector.

For example, it is assumed that the second query vector is Qₜ, the second key vector is Kₜ, the second value vector is Vₜ, and the dimension of the second key vector is dkₜ. The second key vector Kₜ is transposed to obtain a transposed second key vector Kₜ^{T}. The transposed second key vector Kₜ^{T} is multiplied by the second query vector Qₜ to obtain a ninth multiplication result QₜKₜ^{T}. The ninth multiplication result QₜKₜ^{T} is divided by a square root \sqrt{dkₜ} of the dimension of the second key vector to obtain a second division result

$$( \frac{{Q}_{t} {K}_{t}^{T}}{\sqrt{d {k}_{t}}} ) .$$

The second division result

$$\frac{{Q}_{t} {K}_{t}^{T}}{\sqrt{d {k}_{t}}}$$

is normalized by using the softmax function to obtain a normalized second division result

$$softmax ( \frac{{Q}_{t} {K}_{t}^{T}}{\sqrt{d {k}_{t}}} ) .$$

Finally, the normalized first division result

$$softmax ( \frac{{Q}_{t} {K}_{t}^{T}}{\sqrt{d {k}_{t}}} )$$

is multiplied by the second value vector Vₜ to obtain a tenth multiplication result

$$softmax ( \frac{{Q}_{t} {K}_{t}^{T}}{\sqrt{d {k}_{t}}} ) {V}_{t} .$$

In other words, the transformed text feature vector is

$$softmax ( \frac{{Q}_{t} {K}_{t}^{T}}{\sqrt{d {k}_{t}}} ) {V}_{t} .$$

In an example, before operation 102 is performed, the following processing may further be performed: extracting features of the sample object to obtain an audio feature and a text feature of the sample object; and performing embedding processing on the audio feature and the text feature of the sample object, to obtain the audio feature vector and the text feature vector.

For example, it is assumed that there is a task, and features need to be extracted from data information of a user comment on social media. The user comment includes an audio comment and a text comment. First, the audio comment of the user is transformed into an audio signal, and audio features are extracted by using an audio processing technology (for example, short-time Fourier transform or mel-frequency cepstral coefficient). The audio features may include tone, volume, frequency distribution, and the like of audio. In addition, for the text comment of the user, a technology like a bag-of-words model, TF-IDF, or word embedding (for example, Word2Vec or GloVe) may be used to extract text features. The text features include semantic content of the text. Next, embedding processing is performed on the extracted audio features (for example, the embedding processing is performed by using an embedding layer), to obtain an audio feature vector of the audio comment of the user, and embedding processing (for example, a word embedding technology) is performed on the extracted text features, to obtain a text feature vector of the text comment of the user. In this way, original audio and text data are transformed into structured feature representations that can be processed by the machine learning model, to help an emotion classification model accurately predict a user emotion.

Operation 103: Perform classification based on the transformed audio feature vector and the transformed text feature vector by using a linear layer of the emotion classification model, to obtain an emotion classification result of the sample object.

In an aspect, the performing classification based on the transformed audio feature vector and the transformed text feature vector by using a linear layer of the emotion classification model, to obtain an emotion classification result of the sample object may be implemented in the following manner: concatenating the transformed audio feature vector and the transformed text feature vector, to obtain a third concatenated vector; multiplying the third concatenated vector by a first parameter in the linear layer to obtain an eleventh multiplication result; adding the eleventh multiplication result and a second parameter in the linear layer to obtain an addition result; and normalizing the addition result, and using an obtained normalized addition result as the emotion classification result of the sample object.

For example, it is assumed that the transformed audio feature vector is Rᵥ, and the transformed text feature vector is Rₜ. The transformed audio feature vector Rᵥ is concatenated with the transformed text feature vector R₁, to obtain a third concatenated vector X. Assuming that the first parameter of the linear layer is w, and a second parameter of the linear layer is b, the third concatenated vector X is multiplied by the first parameter w in the linear layer, to obtain an eleventh multiplication result wX. The first multiplication result is added with the second parameter b in the linear layer to obtain an addition result wX+b. The addition result is normalized by using the softmax function to obtain a normalized addition result softmax(wX+b). In other words, the emotion classification result of the sample object is softmax(wX+b).

Operation 104: Update the audio prompt vector, the text prompt vector, and the linear layer based on a difference between the emotion classification result and a pre-added label.

Here, the pre-trained transformer model, an updated linear layer, an updated audio prompt vector, and an updated text prompt vector are configured for forming a trained emotion classification model.

In an aspect, the updating the audio prompt vector, the text prompt vector, and the linear layer based on a difference between the emotion classification result and a pre-added label may be implemented in the following manner: substituting the emotion classification result and the pre-added label into a loss function, to obtain the corresponding difference; and keeping parameters of the pre-trained transformer model unchanged, and updating/adjusting a parameter of the linear layer, the audio prompt vector, and the text prompt vector based on the difference.

Here, the loss function may be a cross-entropy loss function, a binary cross-entropy loss function, or a mean square error loss function. The specific loss function may be specifically determined according to a requirement of the model, and is not specifically limited herein.

In an aspect, a prediction result (the emotion classification result) of the model is compared with the pre-added label, and a difference between the two results is calculated by using the loss function (such as a cross-entropy loss or a mean square error), to obtain the corresponding difference. Parameters of the pre-trained transformer model are kept unchanged, backpropagation is performed based on the obtained difference, and the parameters (the first parameter and the second parameter) of the linear layer, the audio prompt vector, and the text prompt vector are updated during the backpropagation.

This process may require a plurality of iterations and adjustment to hyperparameters (such as a learning rate, a batch size, and a quantity of iterations), to optimize model performance. In addition, calculation efficiency and accuracy of the backpropagation may be improved by using various technologies and optimization methods, such as gradient check, batch normalization, and weight initialization strategies.

In an aspect, the updating a parameter of the linear layer, the audio prompt vector, and the text prompt vector based on the difference may be implemented in the following manner: performing backpropagation based on the difference, and separately determining a gradient of the parameter of the linear layer, a gradient of the audio prompt vector, and a gradient of the text prompt vector during the backpropagation; and separately updating the parameter of the linear layer, the audio prompt vector, and the text prompt vector based on the gradients.

The audio prompt vector and text prompt vector, as a special vector layer, are special parameters that may be considered as special weights in the emotion classification model.

For example, the backpropagation is performed according to the calculated difference. During the backpropagation, gradients of the first parameter and the second parameter in the linear layer are first calculated, and the first parameter and the second parameter in the linear layer are updated based on the gradients, to obtain an updated first parameter and second parameter. Next, the gradient of the audio prompt vector and the gradient of the text prompt vector are separately calculated, and the audio prompt vector and the text prompt vector are separately updated based on the gradients. According to this process, a new emotion classification task may be adapted to by fine-tuning only the parameter of the linear layer, the audio prompt vector, and the text prompt vector, without changing the parameters of the pre-training transformer model, so that parameters of the model that need to be trained are reduced, training costs are reduced, and high accuracy can be achieved by using a small amount of training data.

The following continues to describe the emotion classification method according to aspects of this disclosure.

In an aspect, for an object whose emotion is to be classified, an emotion classification model is invoked for classification based on a text feature vector and an audio feature vector of the object, to obtain an emotion classification result of the object. The emotion classification model is obtained by training according to an emotion classification model training method.

For example, it is assumed that on a social media platform, users express their emotions through text comments and audio comments. A user makes a text comment: “The product is terrible, I will never buy it again!”. Similarly, the user further makes an audio comment. As an example, the text comment may be a transcript of the audio comment. Next, the text comment is transformed into a text feature vector by using a word embedding technology, and an audio feature vector in the audio comment is extracted by using an audio processing technology. Subsequently, the text feature vector and the audio feature vector are input to a trained emotion classification model for classification. The model correspondingly outputs an emotion classification result (for example, “negative emotion”) according to the input multi-modality feature vectors.

As an example, a prompt-tuning model training method is used. All parameters of a pre-trained model are frozen, and parameter training is performed on prompt word vectors, so that parameters that need to be trained are reduced exponentially, and a problem of over-fitting caused by fine-tuning can be better avoided. Because both audio and text modalities are trained through prompt-tuning, the problems of over-fitting and under-fitting between modalities caused by fitting difficulty inconsistency between two modalities during prompt-tuning can be avoided, so that a model obtained has higher accuracy than that obtained by training through prompt-tuning.

In addition, in telemarketing and customer service scenarios, labeling of multi-modality data is challenging, and costs of large-scale labeling is high. In addition, a fine-tuning training method has a high requirement on the amount of training data. On the other hand, a better prediction result can be obtained in model training with a smaller amount of data by using the prompt-tuning training method, which is therefore more suitable for practical service needs. For example, in a test performed in a telemarketing scenario, only 500 pieces of training data are needed to achieve a model classification accuracy of higher than 94%, and service use requirements can be completely met. In addition, in a telemarketing scenario, the accuracy of emotion classification (negative emotions and non-negative emotions) performed on customer emotions based on text and audio by the emotion classification model obtained by using the emotion classification model training method provided in this disclosure reaches higher than 95%.

In addition, Table 1 is a table of comparison between effects of the emotion classification model in this disclosure and the related art. According to Table 1, a classification effect of the emotion classification model provided in this disclosure achieves the best performance when model training is performed by using an internationally authoritative multi-emotion classification public data set, IEMOCAP.

TABLE 1
Table of comparison between effects of the emotion classification
model of this disclosure and the related art

| Model | Accuracy ACC |
|---|---|
| Multi-modality emotion recognition (MMER) model | 81.7% |
| Domain adversarial neural network (DANN) model | 82.7% |
| This disclosure model | 83.1% |

The following describes examples of an emotion classification model training method and an emotion classification method in a telemarketing scenario.

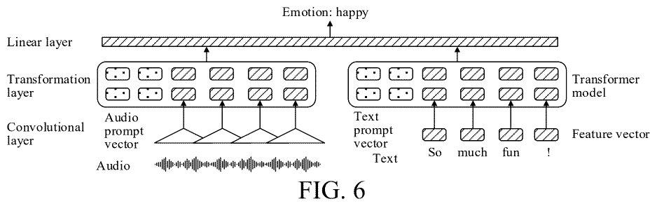

FIG. 6 is a schematic diagram of the emotion classification model training method according to an aspect of this disclosure. An emotion classification model includes a transformation layer and a linear layer. The emotion classification model training method and the emotion classification method are specifically described with reference to FIG. 6.

During training of the emotion classification model, features are extracted from audio information of a sample object by using a 1-dimensional convolutional neural network (CNN1D), to obtain an audio feature of the sample object, embedding processing is performed on the audio feature to obtain an audio feature vector. Subsequently, the audio feature vector is input to an audio modality transformation layer. Embedding processing is performed on text information of the sample object by using a Tokenizer, to obtain a text feature vector. Subsequently, the text feature vector is input into a text modality transformation layer.

Here, a self-attention algorithm is used in the transformation layer. Refer to FIG. 6. An audio modality transformation layer includes an audio prompt vector and a pre-trained transformer model, and the text modality transformation layer includes a text prompt vector and a pre-trained transformer model. In a model training process, parameters of the pre-trained transformer model in the transformation layer are completely frozen, and only the audio prompt vector and the text prompt vector need to be updated.

A self-attention mechanism part in a conventional transformation layer may be represented by using equations (1) to (4).

$$Q = X \cdot {W}_{Q} \qquad ( 1 )$$

$$K = X \cdot {W}_{K} \qquad ( 2 )$$

$$V = X \cdot {W}_{V} \qquad ( 3 )$$

$$Attention ( Q , K , V ) = softmax ( \frac{{QK}^{T}}{\sqrt{dk}} ) V \qquad ( 4 )$$

Q is a query vector, K is a key vector, V is a value vector, X is an embedding representation of an input sequence, W_{Q}, W_{K}, and W_{V} are weight matrices of query, key, and value, respectively, and dk is a dimension of a key vector.

In an example, a prompt-tuning training method is used. A trainable prompt vector weight is added before each of the key vector K and the value vector V, and a modified self-attention part may be represented by using equations (5) to (9).

$$P\_X = cat ( P , X ) \qquad ( 5 )$$

$$Q = X \cdot {W}_{Q} \qquad ( 6 )$$

$$P\_K = P\_X \cdot {W}_{K} \qquad ( 7 )$$

$$P\_V = P\_X \cdot {W}_{V} \qquad ( 8 )$$

$$Attention ( Q , K , V ) = softmax ( \frac{{QK}^{T}}{\sqrt{dk}} ) P\_V \qquad ( 9 )$$

P_X is a trainable prompt word vector weight added before key and value in self-attention in two modalities, P is a prompt vector to be adjusted, X is an embedding representation of an input sequence, P_K is a key vector of a modified self-attention mechanism, and P V is a value vector of the modified self-attention mechanism.

Calculation is performed by using the foregoing self-attention mechanism, to obtain a transformed audio feature vector and a transformed text feature vector, and the transformed audio feature vector and the transformed text feature vector are jointly input to the linear layer, to combine features in a plurality of dimensions. Formula (10) may be used for implementation. Next, a score of emotion classification is calculated through softmax according to formula (11). Emotion classification is performed based on the score, to obtain an emotion classification result. The emotion classification result and a pre-added label are substituted into a loss function, to obtain a corresponding difference. Parameters of the pre-trained transformer model are kept unchanged, and a parameter of the linear layer, the audio prompt vector, and the text prompt vector are updated based on the difference.

Here, the linear layer includes a trainable first parameter and second parameter.

$$x = cat ( Audio\_Encoder ( input\_audio ) , Text\_Encoder ( input\_text ) ) \qquad ( 10 )$$

$$Emo\_Score = softmax ( wx + b ) \qquad ( 11 )$$

Audio_Encoder represents an overall audio feature extractor module. Text_Encoder represents an overall text extractor module. A final output emotion result score is Emo_score. w is a weight of a model in the linear layer, b is a bias of the model in the linear layer, and w and b are both obtained through model training.

During emotion classification, for an object whose emotion needs to be classified, an emotion classification model is invoked to perform classification based on the text feature vector and the audio feature vector of the object, to obtain an emotion classification result of the object.

The following continues to describe an example structure in which an emotion classification model training apparatus 543 provided in this disclosure is implemented as a software module. In an aspect, as shown in FIG. 2A, the software module of the emotion classification model training apparatus 543 stored in a memory 540 may include: an addition module 5431, a transformation module 5432, a prediction module 5433, and an update module 5434.

The addition module 5431 is configured to add an audio prompt vector and a text prompt vector to a transformation layer of an emotion classification model. The transformation module 5432 is configured to transform an audio feature vector of a sample object by using the transformation layer, to obtain a transformed audio feature vector, and transform a text feature vector of the sample object by using the transformation layer, to obtain a transformed text feature vector. The prediction module 5433 is configured to perform classification based on the transformed audio feature vector and the transformed text feature vector by using a linear layer, to obtain an emotion classification result of the sample object. The update module 5434 is configured to update the linear layer, the audio prompt vector, and the text prompt vector based on a difference between the emotion classification result and a pre-added label.

In an aspect, the transformation layer includes a first attention mechanism and a second attention mechanism. The transformation module 5432 is further configured to: transform the audio feature vector by using the first attention mechanism, to obtain the transformed audio feature vector; and transform the text feature vector by using the second attention mechanism, to obtain the transformed text feature vector.

In an aspect, the transformation module 5432 is further configured to: concatenate the audio prompt vector and the audio feature vector to obtain a first concatenated vector; determine a first query vector, a first key vector, and a first value vector of the first attention mechanism based on the first concatenated vector and the audio feature vector; and determine the transformed audio feature vector based on the first query vector, the first key vector, and the first value vector.

In an aspect, the transformation module 5432 is further configured to: multiply the audio feature vector by a first weight matrix, and use an obtained first multiplication result as the first query vector; multiply the first concatenated vector by a second weight matrix, and use an obtained second multiplication result as the first key vector; and multiply the first concatenated vector by a third weight matrix, and use an obtained third multiplication result as the first value vector.

In an example, the transformation module 5432 is further configured to: transpose the first key vector to obtain a transposed first key vector; multiply the transposed first key vector by the first query vector to obtain a fourth multiplication result; divide the fourth multiplication result by a square root of a dimension of the first key vector to obtain a first division result; normalize the first division result to obtain a normalized first division result; and multiply the normalized first division result by the first value vector, and use an obtained fifth multiplication result as the transformed audio feature vector.

In an example, the transformation module 5432 is further configured to: concatenate the text prompt vector and the text feature vector to obtain a second concatenated vector; determine a second query vector, a second key vector, and a second value vector of the second attention mechanism based on the second concatenated vector and the text feature vector; and determine the transformed text feature vector based on the second query vector, the second key vector, and the second value vector.

In an example, the transformation module 5432 is further configured to: multiply the text feature vector by a fourth weight matrix, and use an obtained sixth multiplication result as the second query vector; multiply the second concatenated vector by a fifth weight matrix, and use an obtained seventh multiplication result as the second key vector; and multiply the second concatenated vector by a sixth weight matrix, and use an obtained eighth multiplication result as the second value vector.

In an example, the transformation module 5432 is further configured to: transpose the second key vector to obtain a transposed second key vector; multiply the transposed second key vector by the second query vector to obtain a ninth multiplication result; divide the ninth multiplication result by a square root of a dimension of the second key vector to obtain a second division result; normalize the second division result to obtain a normalized second division result; and multiply the normalized second division result by the second value vector, and use an obtained tenth multiplication result as the transformed text feature vector.

In an example, the transformation layer further includes a pre-trained transformer model. The update module 5434 is further configured to: substitute the emotion classification result and the pre-added label into a loss function, to obtain the corresponding difference; and keep parameters of the pre-trained transformer model unchanged, and update a parameter of the linear layer, the audio prompt vector, and the text prompt vector based on the difference.

In an example, the update module 5434 is further configured to: perform backpropagation based on the difference, and separately determine a gradient of the parameter of the linear layer, a gradient of the audio prompt vector, and a gradient of the text prompt vector during the backpropagation; and separately update the parameter of the linear layer, the audio prompt vector, and the text prompt vector based on the gradients.

In an aspect, as shown in FIG. 2B, the software modules of the emotion classification apparatus 643 stored in the memory 640 may include: a classification module 6431.

The classification module 6431 is configured to invoke, for an object whose emotion is to be classified, an emotion classification model for classification based on a text feature vector and an audio feature vector of the object, to obtain an emotion classification result of the object. The emotion classification model is obtained by training according to the emotion classification model training method provided in aspects of this disclosure.

The foregoing descriptions of the apparatus in this disclosure are similar to the foregoing descriptions of the method, and the apparatus has beneficial effects similar to the method of this disclosure, and therefore is not described in detail. For technical details not mentioned in the emotion classification model training apparatus provided in aspects of this disclosure, reference may be made to the descriptions of any one of FIG. 3, FIG. 4, and FIG. 5.

An aspect of this disclosure provides a computer program product. The computer program product includes a computer program or computer-executable instructions. The computer program or the computer-executable instructions are stored in a computer-readable storage medium. A processor of an electronic device reads the computer-executable instructions from the computer-readable storage medium, and the processor executes the computer-executable instructions, to cause the electronic device to execute the emotion classification model training method or the emotion classification method according to aspects of this disclosure.

An aspect of this disclosure provides a computer-readable storage medium, such as a non-transitory computer-readable storage medium, having computer-executable instructions or a computer program stored thereon. When executed by a processor, the computer-executable instructions or the computer program causes the processor to execute the emotion classification model training method or the emotion classification method according to aspects of this disclosure, for example, the emotion classification model training method shown in FIG. 3, FIG. 4, or FIG. 5.

In an aspect, the computer-readable storage medium may be a memory such as a ferromagnetic random access memory (FRAM), a read-only memory (ROM), a programmable read-only memory (PROM), an erasable programmable read-only memory (EPROM), an electrically erasable programmable read-only memory (EEPROM), a flash memory, a magnetic memory, an optic disc, or a compact disc read-only memory (CD-ROM), or may be various devices including one of or any combination of the foregoing memories.

In an aspect, the computer-executable instructions may be written in the form of a program, software, a software module, a script, or code in a programming language (including a compiler or interpreter language or a declarative or procedural language) in any form, and may be deployed in any form, including an independent program or a module, a component, a subroutine, or another unit suitable for use in a computing environment.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

As an example, the computer-executable instructions may correspond to a file in a file system, and may be stored in a part of a file that stores other programs or data, for example, stored in one or more scripts in a hypertext markup language (HTML) document, stored in a single file dedicated to the program under discussion, or stored in a plurality of collaborative files (for example, a file that stores one or more modules, subroutines, or code parts).

As an example, the computer-executable instructions may be deployed to be executed on one electronic device or on a plurality of electronic devices located at one location, or executed on a plurality of electronic devices distributed at a plurality of locations and interconnected through a communication network.

Aspects of this disclosure can include the following beneficial effects:

(1) An audio modality-based prompt-timing module enables audio information to be better utilized, thereby enhancing capabilities of a multi-modality model.

(2) Both a text modality and an audio modality are obtained through prompt-tuning training based on a multi-modality framework. Parameters of a pre-trained model are frozen during training, so that a problem of fitting degree inconsistency between modalities caused by finish-tuning is avoided, and a better balance between fitting capabilities of multi-modality modules is achieved, thereby improving an overall model effect.

(3) Better effects are achieved generally in small-sample learning, and costs of model training can be effectively reduced. This makes it more advantageous in fields where multi-modality labeling is costly.

The foregoing descriptions are merely examples of this disclosure and are not intended to limit the scope of this disclosure. Any modification, equivalent replacement, or improvement made within the spirit and scope of this disclosure fall within the scope of this disclosure.

What is claimed is:

1. A method for training an emotion classification model, the method comprising:
obtaining a training object and an emotion classification model;
adding an audio vector of the training object and a text vector of the training object to a transformation layer of the emotion classification model;
obtaining a transformed audio feature vector of a sample of the training object based on the transformation layer, and obtaining a transformed text feature vector of the sample of the training object based on the transformation layer;
performing classification based on the transformed audio feature vector, the transformed text feature vector, and a linear layer of the emotion classification model;
obtaining an adjustment based on an emotion classification result of the sample of the training object; and
updating the audio vector, the text vector, and the linear layer of the emotion classification result based on the adjustment.

2. The method according to claim 1, wherein
the transformation layer comprises a first attention mechanism and a second attention mechanism;
the transformed audio feature vector is obtained based on the first attention mechanism; and
the transformed text feature vector is obtained based on the second attention mechanism.

3. The method according to claim 2, wherein the obtaining the transformed audio feature vector further comprises:
concatenating the audio vector and the audio feature vector to obtain a first concatenated vector;
determining a first query vector, a first key vector, and a first value vector of the first attention mechanism based on the first concatenated vector; and
determining the transformed audio feature vector based on the first query vector, the first key vector, and the first value vector.

4. The method according to claim 3, wherein the determining the first query vector, the first key vector, and the first value vector of the first attention mechanism further comprises:
multiplying the audio feature vector by a first weight matrix as the first query vector;
multiplying the first concatenated vector by a second weight matrix as the first key vector; and
multiplying the first concatenated vector by a third weight matrix as the first value vector.

5. The method according to claim 3, wherein the determining the transformed audio feature vector further comprises:
obtaining a transposed first key vector based on the first key vector;
multiplying the transposed first key vector by the first query vector to obtain a first result;
dividing the first result by a square root of a dimension of the first key vector to obtain a second result;
normalizing the second result to obtain a normalized second result; and
multiplying the normalized second result by the first value vector as the transformed audio feature vector.

6. The method according to claim 1, wherein
the transformation layer further comprises a pre-trained transformer model; and
the updating further comprises:
inputting the emotion classification result and a pre-added label into a loss function, to obtain the adjustment; and
keeping parameters of the pre-trained transformer model unchanged, and updating a parameter of the linear layer, the audio vector, and the text vector based on the adjustment.

7. The method according to claim 6, wherein the updating the parameter further comprises:
performing backpropagation based on the adjustment, and determining a gradient of the parameter of the linear layer, a gradient of the audio vector, and a gradient of the text vector; and
updating the parameter of the linear layer, the audio vector, and the text vector based on the gradients respectively.

8. The method according to claim 1, wherein
the training object includes audio information and text information;
the text information is generated from speech of the audio information; and
the training object is a conversation between a service provider and a user.

9. An apparatus for training an emotion classification model, the apparatus comprising:
processing circuitry configured to
obtain a training object and an emotion classification model;
add an audio vector of the training object and a text vector of the training object to a transformation layer of the emotion classification model;
obtain a transformed audio feature vector of a sample of the training object based on the transformation layer, and obtain a transformed text feature vector of the sample of the training object based on the transformation layer;
perform classification based on the transformed audio feature vector, the transformed text feature vector, and a linear layer of the emotion classification model;
obtain an adjustment based on an emotion classification result of the sample of the training object; and
update the audio vector, the text vector, and the linear layer of the emotion classification result based on the adjustment.

10. The apparatus according to claim 9, wherein
the transformation layer comprises a first attention mechanism and a second attention mechanism;
the transformed audio feature vector is obtained based on the first attention mechanism; and
the transformed text feature vector is obtained based on the second attention mechanism.

11. The apparatus according to claim 10, wherein the processing circuitry is configured to:
concatenate the audio vector and the audio feature vector to obtain a first concatenated vector;
determine a first query vector, a first key vector, and a first value vector of the first attention mechanism based on the first concatenated vector; and
determine the transformed audio feature vector based on the first query vector, the first key vector, and the first value vector.

12. The apparatus according to claim 11, wherein the processing circuitry is configured to:
multiply the audio feature vector by a first weight matrix as the first query vector;
multiply the first concatenated vector by a second weight matrix as the first key vector; and
multiply the first concatenated vector by a third weight matrix as the first value vector.

13. The apparatus according to claim 11, wherein the processing circuitry is configured to:
obtain a transposed first key vector based on the first key vector;
multiply the transposed first key vector by the first query vector to obtain a first result;
divide the first result by a square root of a dimension of the first key vector to obtain a second result;
normalize the second result to obtain a normalized second result; and
multiply the normalized second result by the first value vector as the transformed audio feature vector.

14. The apparatus according to claim 9, wherein
the transformation layer further comprises a pre-trained transformer model; and
the processing circuitry is configured to:
input the emotion classification result and a pre-added label into a loss function, to obtain the adjustment; and
keep parameters of the pre-trained transformer model unchanged, and update a parameter of the linear layer, the audio vector, and the text vector based on the adjustment.

15. The apparatus according to claim 14, wherein the processing circuitry is configured to:
perform backpropagation based on the adjustment, and determining a gradient of the parameter of the linear layer, a gradient of the audio vector, and a gradient of the text vector; and
update the parameter of the linear layer, the audio vector, and the text vector based on the gradients respectively.

16. The apparatus according to claim 9, wherein
the training object includes audio information and text information;
the text information is generated from speech of the audio information; and
the training object is a conversation between a service provider and a user.

17. A non-transitory computer-readable storage medium, storing instructions which when executed by a processor cause the processor to perform:
obtaining a training object and an emotion classification model;
adding an audio vector of the training object and a text vector of the training object to a transformation layer of the emotion classification model;
obtaining a transformed audio feature vector of a sample of the training object based on the transformation layer, and obtaining a transformed text feature vector of the sample of the training object based on the transformation layer;
performing classification based on the transformed audio feature vector, the transformed text feature vector, and a linear layer of the emotion classification model;
obtaining an adjustment based on an emotion classification result of the sample of the training object; and
updating the audio vector, the text vector, and the linear layer of the emotion classification result based on the adjustment.

18. The non-transitory computer-readable storage medium according to claim 17, wherein
the transformation layer comprises a first attention mechanism and a second attention mechanism;
the transformed audio feature vector is obtained based on the first attention mechanism; and
the transformed text feature vector is obtained based on the second attention mechanism.

19. The non-transitory computer-readable storage medium according to claim 18, wherein the obtaining the transformed audio feature vector further comprises:
concatenating the audio vector and the audio feature vector to obtain a first concatenated vector;
determining a first query vector, a first key vector, and a first value vector of the first attention mechanism based on the first concatenated vector; and
determining the transformed audio feature vector based on the first query vector, the first key vector, and the first value vector.

20. The non-transitory computer-readable storage medium according to claim 19, wherein the determining the first query vector, the first key vector, and the first value vector of the first attention mechanism further comprises:
multiplying the audio feature vector by a first weight matrix as the first query vector;
multiplying the first concatenated vector by a second weight matrix as the first key vector; and
multiplying the first concatenated vector by a third weight matrix as the first value vector.
